(19) United States
(12) Patent Application Publication
(10) Pub. No.: US 2020/0180111 A1
(43) Pub. Date: Jun. 11, 2020

(54) Fine polishing device for glass bottle mouth

(71) Applicant: Jinwei Lian, Weihai City (CN)

(72) Inventor: Jinwei Lian, Weihai City (CN)

(21) Appl. No.: 16/788,274

(22) Filed: Feb. 11, 2020

(51) Int. Cl. B24D 7/06; C03C 19/00

(52) U.S. Cl. CPC B24D 7/066; C03C 19/00

(57) ABSTRACT

The invention discloses a glass bottle mouth fine grinding device, which includes a working box and a working chamber located in the working box. A placing box is slidably arranged in the working chamber. The placing box is provided with a placing chamber. A glass bottle is slidably disposed in the placement cavity, and first cavities are symmetrically arranged on the left and right sides of the placement cavity. A circular clamping block is slidably disposed in the first cavity. The first cavity is connected by a first spring, and a second cavity is provided at the bottom of the placing box. A sliding block is slidably disposed in the second cavity, and the sliding block and the second cavity are connected by a second spring.

### CROSS-REFERENCES TO RELATED APPLICATIONS

The present application claims priority from Chinese application No. 2019111024017 filed on Nov. 12, 2019 which is hereby incorporated by reference in its entirety.

### TECHNICAL FIELD

The present invention relates to the field of glass grinding equipment, in particular to a fine polishing device for glass bottle mouth.

### BACKGROUND OF THE INVENTION

Glass bottle mouth grinding equipment is a kind of equipment for glass bottle mouth grinding. Traditional glass bottle mouth grinding usually needs to be performed manually. Manual hand-held tools for sanding are not only inefficient, because the round bottle mouth is easy to slip, and it will polish There is a certain danger for personnel, and the safety factor is low. Therefore, a glass bottle mouth fine grinding equipment is urgently needed to solve the above problems. In view of the above disadvantages, the present invention improves.

### BRIEF SUMMARY OF THE INVENTION

The technical problem to be solved by the present invention is to provide a glass bottle mouth fine grinding device, which overcomes the above-mentioned problems.

The present invention is achieved by the following technical solutions.

A glass bottle mouth fine grinding device includes a working box and a working chamber located in the working box. A placing box is slidably arranged in the working chamber, and a placing chamber is provided in the placing box. A glass bottle is slidably arranged, and a first cavity is symmetrically provided on the left and right sides of the placement box. A circular clamping block is slidably disposed in the first cavity, and the circular clamping block is in contact with the first cavity. By a first spring connection, a second cavity is provided at the bottom of the placing box, and a sliding block is slidably disposed in the second cavity, and the sliding block and the second cavity are connected by a second spring. A grinding box is fixed on the top wall of the working chamber. The grinding box is provided with a grinding chamber. The grinding chamber is provided with a rotating rod for rotation. The left end wall of the rotating rod is slidingly provided with a first A turning block, a rough grinding link is fixed on the lower end surface of the first turning block, a rough grinding blade is fixed on the lower end surface of the rough grinding link, and a second turning block is slidably arranged on the right end wall of the turning rod; The lower end surface of the second rotating block is fixedly provided with a fine grinding rod, and the lower end surface of the fine grinding rod is fixedly provided. A grinding blade, a water storage tank is fixed on the left end wall of the grinding tank, a water outlet valve is fixed on the right end wall of the water storage tank, and a water inlet valve on the right side of the water outlet valve is fixed on the left end wall of the grinding tank, A water storage cavity is provided in the water storage tank, and a sliding plate is slidably arranged in the water storage cavity;

When the glass bottle is caught in the placing cavity, the placing box slides upward, the rotating rod rotates, and the rough grinding blade roughens the mouth of the glass bottle. After the rough grinding is finished, the rough The grinding blade is used to finely grind the mouth of the glass bottle through the fine grinding blade, and the sliding plate continuously slides left and right to press the water in the water storage chamber through the water outlet valve and the water inlet valve into the grinding In the cavity, glass dust generated by grinding is adsorbed.

Further, a motor located on the upper side of the rotating rod is fixed on the top wall of the grinding chamber. A motor shaft is dynamically connected to the lower end surface of the motor, and the lower end surface of the motor shaft is fixedly connected to the upper end surface of the rotating rod. The left end wall of the rotating rod is provided with a first chute, an electromagnet is fixed at the bottom of the first chute, and a metal slider is slidably arranged in the first chute. The water valve is fixedly connected, and a second sliding groove is provided on the right end wall of the rotating rod. A first slider is slidably arranged in the second sliding groove, and the first slider and the second sliding groove are passed through a third spring. Connection, the right end surface of the first slider is fixedly connected to the second rotating block, the metal slider and the first slider are connected by a first pull rope, and when the metal slider slides to the first When a chute is at the bottom, the first slider is located at the top of the second chute.

Further, a closed box is fixed in a ring shape at the bottom of the grinding box, and a closed cavity is provided in the closed box. An annular closed plate is slidably arranged in the closed cavity, and the annular closed plate and the closed cavity pass a closed spring. Connected, a sliding box is fixed on the lower end surface of the closed box, and the sliding box is symmetrically arranged on the left and right. The sliding box is provided with a sliding cavity, the sliding cavity is opened downward, and a second slide is provided in the sliding cavity A slider, the second slider is connected to the sliding cavity by a fourth spring, the second slider is connected to the annular closing plate by a second pull rope, and an outer end wall of the top of the placing box is fixedly provided An annular plate, a push rod located at the lower side of the second slider is fixed on an end surface of the annular plate.

Further, a fixing rod located on the left side of the water storage tank is fixed on the top wall of the working cavity, a shaft sleeve is fixed on the lower end surface of the fixing rod, and a first rotating shaft is provided inside the shaft sleeve, and the first A first bevel gear is fixed on the left end wall of a rotating shaft, and a pointed rotating shaft is fixed on the right end face of the first rotating shaft. The pointed rotating shaft extends right into the water storage cavity, and the left end face of the sliding plate is fixed. A fixed block is provided on the right side of the pointed shaft, the pointed shaft abuts the fixed block, a fifth spring is symmetrically arranged on the left end surface of the sliding plate, and the left end of the fifth spring is fixedly connected to The left cavity wall of the water storage cavity.

Further, a push rod box located on the lower side of the placing box is fixed on the bottom wall of the working chamber, and the push rod box is slidingly provided with an electric push rod. The upper end surface of the electric push rod and the lower end surface of the placing box A fixed connection is fixed on the bottom wall of the working cavity. A fixing table located at the rear side of the pushrod box is fixed. The fixing table is symmetrically arranged in the front and back. A third cavity is provided in the fixing table. An inner slide is provided with a slide bar, the slide bar is connected to the third cavity through a sixth spring, and an upper end surface of the slide bar is fixedly connected to a lower end surface of the placing box.

Further, a third chute is provided at the bottom of the work box, and a third slider is slidably arranged in the third chute, and the third slider is connected to the right wall of the third chute through a seventh spring. The third slider is connected to the sliding block through a third pull rope. A sliding rod is fixed on the upper end surface of the third slider, and a sensor is fixed on the right end wall of the sliding rod. When abutting with the push rod box, the push rod box is activated to move the electric push rod upward. A pull rod is fixed on the left end wall of the sliding rod, and the rear cavity wall of the working chamber is provided with the pull rod. A second rotating shaft on the left side, a reel is fixed on the second rotating shaft, and the reel is connected with the pull rod through a fourth pull rope.

Further, a rectangular hole is penetrated through the left end wall of the grinding box, and a third rotating shaft located on the left side of the fixed rod is rotatably provided on the top wall of the working chamber, and the third rotating shaft and the motor rotating shaft pass through a first pulley Transmission connection, the first pulley passes through the rectangular hole, a second bevel gear meshing with the first bevel gear is fixed on the third rotating shaft, and an outer end wall of the third rotating shaft is fixedly located on A third bevel gear is fixed on the outer end wall of the one-way bearing under the second bevel gear.

Further, a fourth rotating shaft located on the left side of the second rotating shaft is provided on the back cavity wall of the working cavity, and a fourth bevel gear meshing with the third bevel gear is fixed on the fourth rotating shaft. The fourth rotating shaft and the second rotating shaft are drivingly connected through a second pulley.

Beneficial effects of the present invention: The present invention changes the traditional manual grinding to automatic grinding. The glass bottle to be polished is clamped into the clamping device. The sealing device of the invention closes the grinding cavity. The rough grinding knife firstly faces the glass bottle mouth. Rough grinding. When grinding, pass water into the grinding chamber to absorb the glass dust produced by grinding. After the rough grinding is completed, replace it with a fine grinding knife to finely polish the glass bottle mouth after rough grinding. Use full automation instead of manual grinding. While improving work efficiency, but also to avoid the safety problems caused by grinding.

### BRIEF DESCRIPTION OF THE DRAWINGS

The present invention will be described in detail below with reference to FIGS. 1-4. For convenience of description, the orientation described below is defined as follows: the up-down-left-right-back direction described below is consistent with the up-down-left-right-left direction of the projection relationship of FIG.

FIG. 1 is a schematic diagram of the overall structure of a glass bottle mouth fine grinding device according to the present invention; FIG.

FIG. 2 is a schematic structural diagram at A-A in FIG. 1; FIG.

FIG. 3 is a schematic structural diagram at B in FIG. 1; FIG.

FIG. 4 is a schematic structural diagram at C in FIG. 1.

### DETAILED DESCRIPTION OF THE INVENTION

The present invention is further described below with reference to the accompanying drawings and embodiments. The modes of the present invention include but are not limited to the following embodiments.

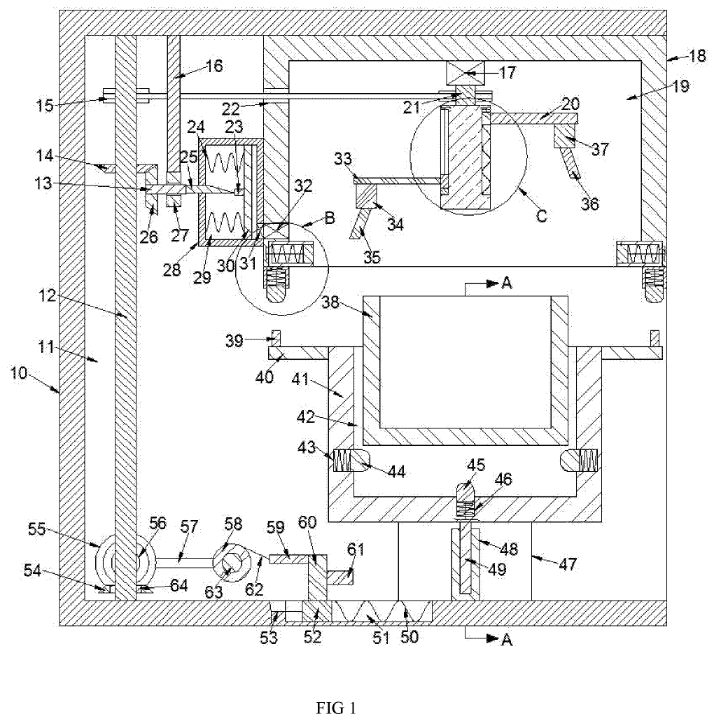

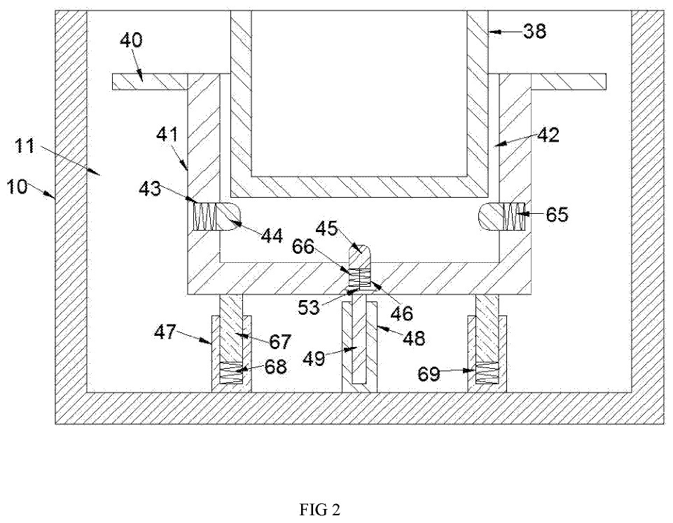

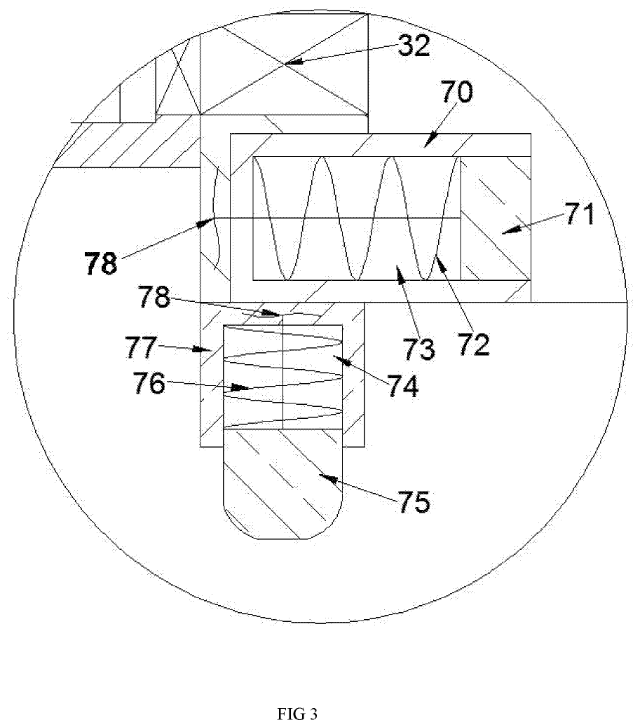

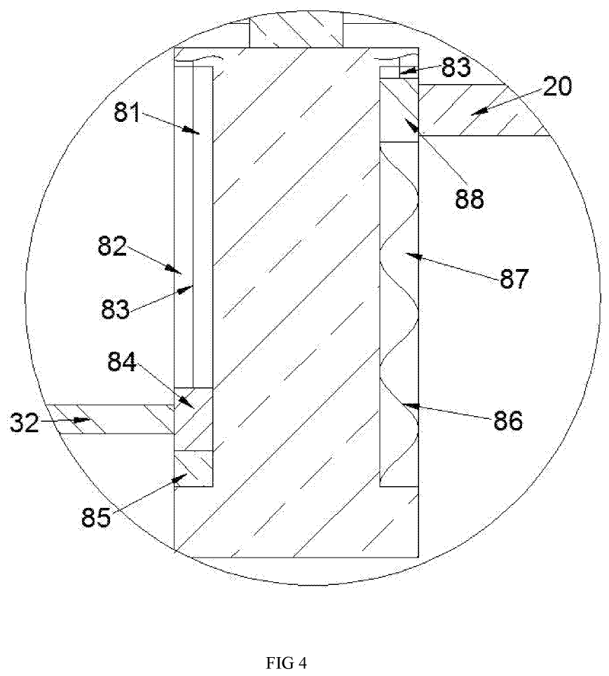

As shown in FIG. 1-4, a glass bottle mouth fine grinding device includes a work box 10 and a work chamber 11 located in the work box 10, and a placing box 41 is slid up and down in the work chamber 11, A placing cavity 42 is provided in the placing box 41, and a glass bottle 38 is slidably arranged in the placing cavity 42. A first cavity 43 is symmetrically provided on the left and right sides in the placing box 41, and the first cavity 43 slides in the first cavity 43. A circular clamping block 44 is provided. The circular clamping block 44 and the first cavity 43 are connected by a first spring 65. A second cavity 46 is provided at the bottom of the placing box 41, and the second cavity A sliding block 45 is slid inside 46, and the sliding block 45 and the second cavity 46 are connected by a second spring 66. A grinding box located on the upper side of the placing box 41 is fixed on the top wall of the working chamber 11. 18, a grinding chamber 19 is provided in the grinding box 18, and a rotating rod 81 is rotatably provided in the grinding chamber 19. A first rotating block 33 is slidably provided on the left end wall of the rotating rod 81. A rough grinding link 34 is fixed on the lower end surface, a rough grinding blade 35 is fixed on the lower end surface of the rough grinding link 34, and a second rotation block 20 is slidably located on the right end wall of the rotating rod 81. The lower end surface of the second rotating block 20 is fixed with a fine grinding rod 37, the lower end surface of the fine grinding rod 37 is fixed with a fine grinding blade 36, and the left end wall of the grinding box 18 is fixed with a water storage tank 28. A water outlet valve 31 is fixed on the right end wall of the water storage tank 28, and a water inlet valve 32 on the right side of the water outlet valve 31 is fixed on the left end wall of the grinding tank 18, and a water storage cavity 29 is provided in the water storage tank 28. A sliding plate 30 is slid in the water storage cavity 29;

When the glass bottle 38 is caught in the placing cavity 42, the placing box 41 slides upward, the rotating rod 81 rotates, and the rough grinding blade 35 rough-grinds the mouth of the glass bottle. The coarse grinding blade 35 is retracted, and the mouth of the glass bottle is finely ground by the fine grinding blade 36. The sliding plate 30 continuously slides left and right to pass the water in the water storage chamber 29 through the water outlet valve 31, The water inlet valve 32 is pressed into the grinding chamber 19 to absorb glass dust generated by grinding.

Beneficially, a motor 17 located on the upper side of the rotating rod 81 is fixed on the top wall of the grinding chamber 19, and a motor shaft 21 is dynamically connected to the lower end surface of the motor 17. The lower end surface of the motor shaft 21 is connected to the rotating rod. The upper end of 81 is fixedly connected. The left end wall of the rotating rod 81 is provided with a first sliding groove 82. An electromagnet 85 is fixed at the bottom of the first sliding groove 82. A metal slider is slidably arranged in the first sliding groove 82. 84. The left end surface of the metal slider 84 is fixedly connected to the water inlet valve 32. The right end wall of the rotating rod 81 is provided with a second sliding groove 87. A first slider is slidably provided in the second sliding groove 87. 88, the first slider 88 and the second slide groove 87 are connected by a third spring 86, the right end surface of the first slider 88 is fixedly connected with the second rotating block 20, and the metal slider 84 The first slider 88 is connected to the first slider 88 through a first pull rope 83. When the metal slider 84 slides to the bottom of the first slide groove 82, the first slider 88 is located in the second slide groove 87. top.

Beneficially, a closed box 70 is fixed in a ring shape at the bottom of the grinding box 18, and a closed cavity 73 is provided in the closed box 70. An annular closed plate 71 is slidably arranged in the closed cavity 73. The annular closed plate 71 and The closed cavity 73 is connected by a closed spring 72. A sliding box 77 is fixed on the lower end surface of the closed box 70. The sliding box 77 is symmetrically arranged left and right. The sliding box 77 is provided with a sliding cavity 74. 74 opens downward, and a second slider 75 is slidably disposed in the sliding cavity 74. The second slider 75 and the sliding cavity 74 are connected by a fourth spring 76, and the second slider 75 and the The ring-shaped closing plate 71 is connected by a second pull rope 78. A ring plate 40 is fixed on the outer end wall of the top of the placing box 41, and a pusher located on the lower side of the second slider 75 is fixed on the upper end surface of the ring plate 40. Rod 39.

Beneficially, a fixing rod 16 on the left side of the water storage tank 28 is fixed on the top wall of the working cavity 11. A shaft sleeve 27 is fixed on the lower end surface of the fixing rod 16. A rotating shaft 13, a first bevel gear 26 is fixed on the left end wall of the first rotating shaft 13, and a pointed shaft 25 is fixed on the right end face of the first rotating shaft 13, and the pointed shaft 25 extends to the right to the storage. In the water cavity 29, the left end surface of the slide plate 30 is fixed with a fixing block 23 located on the right side of the pointed shaft 25, the pointed shaft 25 abuts against the fixed block 23, and the left end of the slide plate 30 A fifth spring 24 is symmetrically arranged on the top and bottom, and the left end of the fifth spring 24 is fixedly connected to the left cavity wall of the water storage cavity 29.

Beneficially, a push rod box 48 located on the lower side of the placing box 41 is fixed on the bottom wall of the working chamber 11. The push rod box 48 is slidingly provided with an electric push rod 49. The lower end surface of the placing box 41 is fixedly connected, and the bottom wall of the working chamber 11 is fixed with a fixing table 47 located at the rear side of the push rod box 48. The fixing table 47 is symmetrically arranged front and rear, and the fixing table 47 is provided inside. There is a third cavity 69, and a sliding rod 67 is slidably disposed in the third cavity 69. The sliding rod 67 and the third cavity 69 are connected by a sixth spring 68. The upper end surface of the sliding rod 67 is in contact with the third cavity 69. The lower end surface of the placing box 41 is fixedly connected.

Beneficially, a third slide groove 51 is provided at the bottom of the work box 10, and a third slider 52 is slidably arranged in the third slide groove 51, and the third slider 52 is to the right of the third slide groove 51. The wall is connected by a seventh spring 50, the third slider 52 and the sliding block 45 are connected by a third pull rope 53, and a sliding rod 60 is fixed on the upper end surface of the third slider 52, and the sliding rod 60 A sensor 61 is fixed on the right end wall. When the sensor 61 is in contact with the push rod box 48, the push rod box 48 starts to move the electric push rod 49 upward, and the left end wall of the sliding rod 60 A tie rod 59 is fixedly installed, and a second rotating shaft 63 on the left side of the pulling rod 59 is rotatably provided on the rear cavity wall of the working cavity 11. A winding wheel 58 is fixed on the second rotating shaft 63. 58 is connected to the pull rod 59 through a fourth pull rope 62.

Beneficially, the left end wall of the grinding box 18 is provided with a rectangular hole 22 penetrating therethrough, and the top wall of the working chamber 11 is rotatably provided with a third rotating shaft 12 located on the left side of the fixing rod 16. The motor rotating shaft 21 is drivingly connected through a first pulley 15, the first pulley 15 passes through the rectangular hole 22, and a second bevel gear 14 meshing with the first bevel gear 26 is fixed on the third rotating shaft 12. A one-way bearing 64 located on the lower side of the second bevel gear 14 is fixed on the outer end wall of the third rotating shaft 12, and a third bevel gear 54 is fixed on the outer end wall of the one-way bearing 64.

Beneficially, a fourth rotating shaft 56 located on the left side of the second rotating shaft 63 is rotatably provided on the rear cavity wall of the working cavity 11, and a fixed first engaging mesh with the third bevel gear 54 is fixed on the fourth rotating shaft 56. In the four-bevel gear 55, the fourth rotating shaft 56 and the second rotating shaft 63 are drivingly connected through a second pulley 57.

The sequence of mechanical actions of the entire device:

The initial state of the present invention is: the electromagnet 85 is energized, the electromagnet 85 attracts the metal slider 84, the first pulling rope 83 is in a tensioned state, the third spring 86 is in a tensioned state, and the first slider 88 is located in the second chute On the upper side of 87, the second spring 66 is in a relaxed state, the third tensioning rope 53 is in a tensioned state, the seventh spring 50 is in a tensioned state, the sensor 61 is not in contact with the push rod box 48, and the second tensioning rope 78 is a tensioning In a tight state, the closed spring 72 is in a compressed state, and the annular closed plate 71 is located in the closed cavity 73;

1. The glass bottle 38 to be polished is snapped into the placement cavity 42, and the glass bottle 38 is fixed in the placement cavity 42 by a circular clamping block 44;

2. The glass bottle 38 presses the sliding block 45 downward, and the sliding block 45 is squeezed downward to relax the third pulling rope 53. The third pulling rope 53 is relaxed to reset the seventh spring 50, and the reset of the seventh spring 50 drives the third sliding The block 52 moves to the right, and the third slider 52 moves to the right to drive the slide bar 60 to the right. The slide bar 60 moves to the right to cause the sensor 61 to contact the putter box 48, the putter box 48 starts, and the putter box 48 starts. The electric push rod 49 is moved upward, and the electric push rod 49 is moved upward to drive the placing box 41 to move upward;

3. The upward movement of the placing box 41 drives the annular plate 40 to move upward, and the upward movement of the annular plate 40 drives the push rod 39 to move upward. When the push rod 39 is in contact with the second slider 75, the second slider 75 is squeezed and moved upward, so that the first The second pull rope 78 is relaxed, and the second pull rope 78 is relaxed to reset the closing spring 72. The resetting of the closing spring 72 ejects the annular closing plate 71, and the annular closing plate 71 is ejected to close the grinding chamber 19;

4. The motor 17 is started. The motor 17 is started to drive the motor shaft 21 to rotate. The motor shaft 21 is rotated to rotate the first rotating block 33. The first rotating block 33 is rotated to rotate the coarse grinding link 34, and the coarse grinding link 34 is rotated to drive the coarse grinding blade 35. Rotate, the coarse grinding blade 35 rotates to roughly grind the glass bottle mouth circumferentially;

5. After rough grinding for a period of time, the electromagnet 85 powers off and repels the metal slider 84, causing the metal slider 84 to move upward. The metal slider 84 moves upward to relax the first pulling rope 83, and the first pulling rope 83 is relaxed to cause the third spring 86 Reset, the third spring 86 resets the first slider 88 to move downward, the first slider 88 moves downward to drive the second rotating block 20 downward, and the second rotary block 20 moves downward to drive the fine grinding link 37 to Downward movement, downward movement of the fine grinding rod 37 drives downward movement of the fine grinding blade 36, and the fine grinding blade 36 rotates to polish the glass bottle mouth;

6. Because the motor shaft 21 and the third shaft 12 are drivingly connected through the first pulley 15, the motor shaft 21 rotates to drive the third shaft 12 to rotate, and the third shaft 12 rotates to drive the second bevel gear 14 to rotate. Bevel gear 26 meshes. Rotation of the second bevel gear 14 drives the first bevel gear 26 to rotate. Rotation of the first bevel gear 26 drives the first shaft 13 to rotate. Rotation of the first shaft 13 drives the pointed shaft 25 to rotate. The sliding plate 30 continuously performs left-right reciprocating motion, and the water in the water storage chamber 29 enters the grinding chamber 19 through the water outlet valve 31 and the water inlet valve 32, and absorbs glass dust generated by the grinding bottle mouth in the grinding chamber 19;

7. After the grinding is completed, the motor 17 starts to rotate in reverse. Under the action of the one-way bearing 64, the third rotating shaft 12 rotates to drive the third bevel gear 54 to rotate. Since the third bevel gear 54 meshes with the fourth bevel gear 55, the third bevel gear The 54 rotation drives the fourth bevel gear 55 to rotate, and the fourth bevel gear 55 rotates to drive the fourth rotation shaft 56. Since the fourth rotation shaft 56 and the second rotation shaft 63 are driven by the second pulley 57, the fourth rotation shaft 56 rotates to drive the second rotation shaft 63 rotation, rotation of the second rotation shaft 63 causes the reel 58 to rotate, and the reel 58 rotates to retract the fourth pull rope 62 to move the pull rod 59 to the left;

8. The movement of the pull rod 59 to the left causes the slide rod 60 to move to the left, and the movement of the slide rod 60 to the left causes the sensor 61 to move to the left. The sensor 61 moves to the left to disengage from the putter box 48, and the putter box 48 stops.

9. The slide bar 67 moves downward under the action of the sixth spring 68. The downward movement of the slide bar 67 drives the placement box 41 to move downward. After the placement box 41 moves downward, the glass bottle 38 in the placement cavity 42 after being polished is removed.

The above embodiments are only for explaining the technical concept and characteristics of the present invention, and the purpose thereof is to enable those skilled in the art to understand and implement the content of the present invention, but not to limit the protection scope of the present invention. Any equivalent change or modification made according to the spirit and essence of the present invention should be covered by the protection scope of the present invention.

1. A glass bottle mouth fine grinding device includes a working box and a working chamber located in the working box. A placing box is slidably arranged in the working chamber. The placing box is provided with a placing chamber. A glass bottle is slidably disposed in the placement cavity, and first cavities are symmetrically arranged on the left and right sides of the placement cavity. A circular clamping block is slidably disposed in the first cavity. The first cavity is connected by a first spring, and a second cavity is provided at the bottom of the placing box. A sliding block is slidably disposed in the second cavity, and the sliding block and the second cavity are connected by a second spring. The top wall of the working chamber is fixedly provided with a grinding box located on the upper side of the placing box. The grinding box is provided with a grinding chamber. The grinding chamber is provided with a rotating rod for rotation, and the left end wall of the rotating rod slides. A first turning block is provided, a rough grinding link is fixed on the lower end surface of the first turning block, a rough grinding blade is fixed on the lower end surface of the rough grinding link, and a second rotation is provided on the right end wall of the turning rod. Block, the second end of the second rotating block is fixed with a fine grinding rod, and the fine grinding rod A precision grinding blade is fixed on the end surface, a water storage tank is fixed on the left end wall of the grinding tank, a water outlet valve is fixed on the right end wall of the water storage tank, and an inlet valve on the right side of the water outlet valve is fixed on the left end wall of the grinding tank. A water valve, a water storage cavity is provided in the water storage tank, and a sliding plate is slidably arranged in the water storage cavity;
When the glass bottle is caught in the placing cavity, the placing box slides upward, the rotating rod rotates, and the rough grinding blade roughens the mouth of the glass bottle. After the rough grinding is finished, the rough The grinding blade is used to finely grind the mouth of the glass bottle through the fine grinding blade, and the sliding plate continuously slides left and right to press the water in the water storage chamber through the water outlet valve and the water inlet valve into the grinding In the cavity, glass dust generated by grinding is adsorbed.

2. The glass bottle mouth fine grinding device according to claim 1, characterized in that: a motor on the upper side of the rotating rod is fixed on the top wall of the grinding chamber, and a motor shaft is dynamically connected to the lower end surface of the motor, The lower end surface of the motor shaft is fixedly connected to the upper end surface of the rotating rod. The left end wall of the rotating rod is provided with a first chute, the bottom of the first chute is fixed with an electromagnet, and the first chute slides inside. A metal slider is provided, the left end surface of the metal slider is fixedly connected to the water inlet valve, a second slide groove is provided on the right end wall of the rotating rod, and a first slider is slidably arranged in the second slide groove. The first slider and the second slider are connected by a third spring, the right end surface of the first slider is fixedly connected with the second rotating block, and the metal slider and the first slider pass through The first pull rope is connected, and when the metal slider slides to the bottom of the first chute, the first slider is located on the top of the second chute.

3. The glass bottle mouth fine grinding device according to claim 1, characterized in that: a closed box is fixed at the bottom of the grinding box, a closed cavity is provided in the closed box, and a sliding cavity is provided in the closed cavity. An annular closing plate is connected to the closing cavity by a closing spring. A sliding box is fixed on the lower end surface of the closing box. The sliding box is symmetrically arranged on the left and right sides. The sliding box is provided with a sliding cavity. The sliding cavity is opened downward, and a second slider is slidably arranged in the sliding cavity. The second slider is connected to the sliding cavity through a fourth spring, and the second slider passes through the annular closed plate. The second pull rope is connected with a ring plate fixed on the outer end wall of the top of the placing box, and a push rod located on the lower side of the second slider is fixed on the end surface of the ring plate.

4. The glass bottle mouth fine grinding device according to claim 1, characterized in that: a fixed rod located on the left side of the water storage tank is fixed on the top wall of the working cavity, and a shaft is fixed on the lower end surface of the fixed rod. A first rotating shaft is rotatably provided in the sleeve, a first bevel gear is fixed on the left end wall of the first rotating shaft, and a pointed shaft is fixed on the right end face of the first rotating shaft, and the pointed shaft is axial Extending to the right into the water storage cavity, the left end surface of the sliding plate is fixed with a fixing block located on the right side of the pointed shaft, the pointed shaft abuts against the fixing block, and the left end surface of the sliding plate is fixed. A fifth spring is symmetrically arranged up and down, and the left end of the fifth spring is fixedly connected to the left cavity wall of the water storage cavity.

5. The glass bottle mouth fine grinding device according to claim 3, characterized in that: a pusher box located on the lower side of the placing box is fixed on the bottom wall of the working chamber, and the pusher box is slidingly provided with an electric motor. A push rod, the upper end surface of the electric push rod is fixedly connected to the lower end surface of the placing box, and the bottom wall of the working cavity is fixed with a fixing table located on the rear side of the putting box, and the fixing table is symmetrically arranged in the front and rear. A third cavity is provided in the fixed table, and a slide bar is slidably disposed in the third cavity. The slide bar is connected to the third cavity through a sixth spring, and an upper end surface of the slide bar is connected to the The lower end of the placing box is fixedly connected.

6. The glass bottle mouth fine grinding device according to claim 5, characterized in that: a third chute is provided at the bottom of the work box, and a third slider is slidably arranged in the third chute, and the first The three sliders are connected to the right wall of the third sliding slot by a seventh spring, the third slider is connected to the sliding block by a third pull rope, and a sliding rod is fixed on the upper end surface of the third slider. A sensor is fixed on the right end wall of the sliding rod. When the sensor is in contact with the push rod box, the push rod box starts to move the electric push rod upward, and the left end wall of the sliding rod is fixed. There is a pull rod, and a second rotating shaft located on the left side of the pulling rod is rotatably provided on the rear cavity wall of the working cavity. A winding roller is fixed on the second rotating shaft, and the winding roller and the pulling rod are pulled through a fourth Rope connection.

7. The equipment for finely polishing a glass bottle mouth according to claim 4, characterized in that: a left end wall of the grinding box is provided with a rectangular hole penetrating through, and a top wall of the working chamber is rotatably provided with a first Three rotating shafts, the third rotating shaft and the motor rotating shaft are drivingly connected through a first pulley, the first pulley passes through the rectangular hole, and the third rotating shaft is fixedly provided with a meshing mesh with the first bevel gear In a second bevel gear, a one-way bearing located on the lower side of the second bevel gear is fixed on the outer end wall of the third rotating shaft, and a third bevel gear is fixed on the outer end wall of the one-way bearing.
The fine grinding device for glass bottle mouth according to claim 6, characterized in that: a fourth rotation shaft located on the left side of the second rotation shaft is provided on the back cavity wall of the working chamber, and the fourth rotation shaft is fixed on the fourth rotation shaft. A fourth bevel gear meshed with the third bevel gear is provided, and the fourth rotating shaft and the second rotating shaft are drivingly connected through a second pulley.
